(19) United States
(12) Patent Application Publication
(10) Pub. No.: US 2011/0208761 A1
(43) Pub. Date: Aug. 25, 2011

(54) COORDINATING CONTENT FROM MULTIPLE DATA SOURCES

(75) Inventors: John Zybura, Seattle, WA (US); Ryan M. Farmer, Redmond, WA (US)

(73) Assignee: Microsoft Corporation, Redmond, WA (US)

(21) Appl. No.: 12/711,359

(22) Filed: Feb. 24, 2010

(51) Int. Cl. G06F 17/30

(52) U.S. Cl. 707/756; 707/769; 707/E17.006; 707/E17.014

(57) ABSTRACT

Content from multiple data sources may be coordinated. A native file may be received at a first client computer from an auxiliary data store. The native file may include metadata such as a document title. The first client computer may then send a reserve title request to a primary data store. The reservation request may include the document title of the native file. The first client computer may then receive a response granting the reserve title request from the primary data store. The response may indicate that the native file is locked from further editing by another client computer. The first client computer may then convert the native file from a proprietary file format to a global file format and send the converted native file to the primary data store.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Computing networks may contain multiple file stores which are accessed by multiple clients. In a shared computing environment, the multiple clients may share access to the same set of files (e.g., files associated with a meeting or conference) on a single destination data store. The multiple clients may further access and store multiple versions of the same set of files on different auxiliary data stores for editing before saving the edited files to the destination data store. Thus, a single file may be edited by multiple clients at the same time on different auxiliary data stores before being saved to the destination data store. As a result, it is often difficult to determine which of a number of versions of the same file on the destination data store is the latest version. Moreover, after being accessed or edited by one or more multiple clients, files may also need to undergo additional processing for conversion into a standardized format for use on the destination data store. This additional processing however, in addition to being time consuming, consumes computing resources of the multiple clients. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for coordinating content from multiple data sources. A native file may be received at a first client computer from an auxiliary data store. The native file may include metadata such as a document title. The first client computer may then send a reserve title request to a primary data store. The reservation request may include the document title of the native file. The first client computer may then receive a response granting the reserve title request from the primary data store. The response may indicate that the native file is locked from further editing by another client computer. The first client computer may then convert the native file from a proprietary file format to a global file format (i.e., a globally viewable document and send the converted native file to the primary data store.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating a client-server network architecture for coordinating content from multiple data sources, in accordance with various embodiments;

FIG. 2 is a block diagram illustrating a client computing environment for coordinating content from multiple data sources, in accordance with various embodiments;

FIG. 3 is a flow diagram illustrating a routine for coordinating content from multiple data sources, in accordance with various embodiments;

FIG. 4A is a block diagram illustrating contents of metadata utilized in coordinating content from multiple data sources, in accordance with an embodiment; and

FIG. 4B is a block diagram illustrating various response codes which may be utilized in coordinating content from multiple data sources, in accordance with an embodiment.

### DETAILED DESCRIPTION

Embodiments are provided for coordinating content from multiple data sources. A native file may be received at a first client computer from an auxiliary data store. The native file may include metadata such as a document title. The first client computer may then send a reserve title request to a primary data store. The reservation request may include the document title of the native file. The first client computer may then receive a response granting the reserve title request from the primary data store. The response may indicate that the native file is locked from further editing by another client computer. The first client computer may then convert the native file from a proprietary file format to a global file format and send the converted native file to the primary data store.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

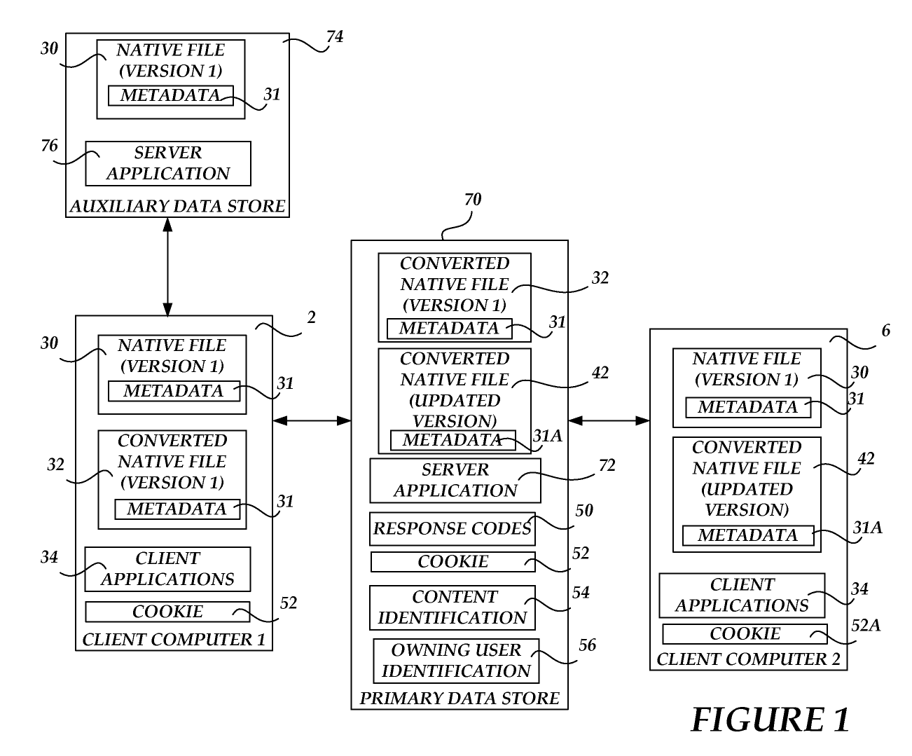

Referring now to the drawings, in which like numerals represent like elements through the several figures, various aspects of the present invention will be described. FIG. 1 is a block diagram illustrating a client-server network architecture which may be utilized for coordinating content from multiple data sources, in accordance with various embodiments. The network architecture includes an auxiliary data store 74 in communication with a client computer 2. The client computer 2 is in communication with the auxiliary data store 74 and a primary data store 70. The primary data store 70 is in communication with the client computer 2 (e.g., a first client computer) and a client computer 6 (e.g., a second client computer). It should be understood that the network architecture of FIG. 1 is not limited solely to the client computers 2 and 6 but may also include additional client computers without departing from the scope of the embodiments discussed herein.

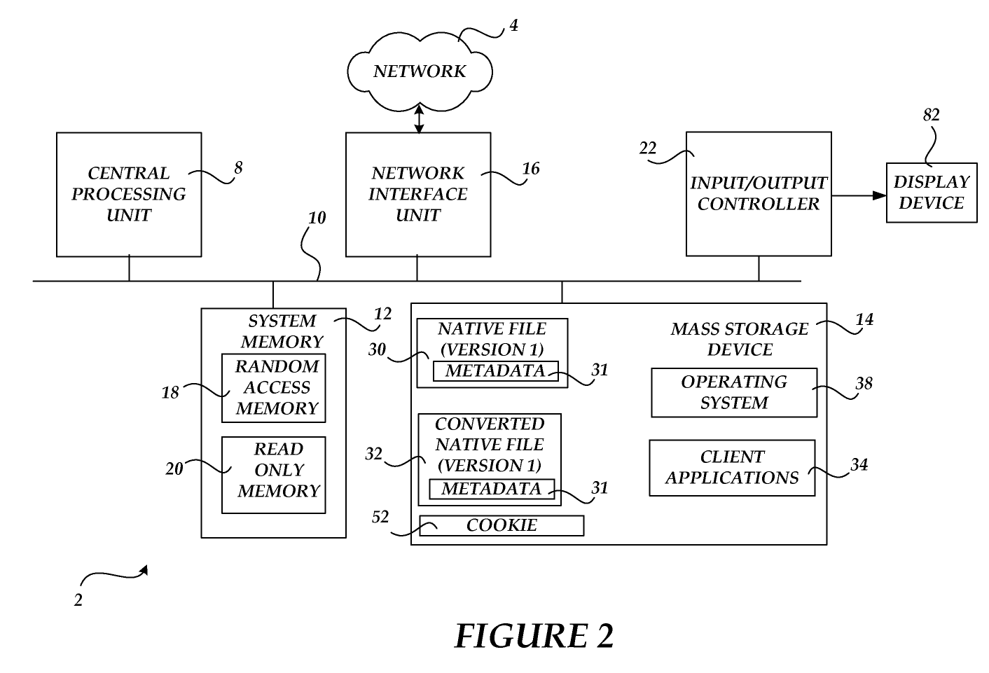

The auxiliary data store 74 may comprise a server computer for storing files and associated metadata. In accordance with an embodiment, the auxiliary data store includes a native file 30 and a server application 76. The native file 30 may include metadata 31. In accordance with an embodiment, the native file 30 may comprise a version of a document (e.g., a word processing document) created and/or updated on the client computer 2 and saved to the auxiliary data store 74 in a proprietary file format. The metadata 31 may include additional information about the native file 30 including, but not limited to, a document title, an external identifier, and a last modification time (i.e., the last time the native file 30 was modified). The metadata 31 will be discussed in greater detail below with respect to FIGS. 2-4, below. The server application 76 may utilize a collaborative services technology such as the SHAREPOINT services technology developed by MICROSOFT CORPORATION of Redmond, Wash. As is known to those skilled in the art, SHAREPOINT services technology enables users to create, maintain, and present a collaborative environment to share information. Using the technology, a user or organization can create one or more files for sharing with other users. It should be understood that the embodiments described herein should not be construed as being limited to SHAREPOINT services technology and that other collaborative services technology from other developers and/or manufacturers may also be utilized. It should be further understood that the embodiments described herein should not be construed as being limited to the aforementioned software applications and that other software applications from other developers and/or manufacturers may also be utilized.

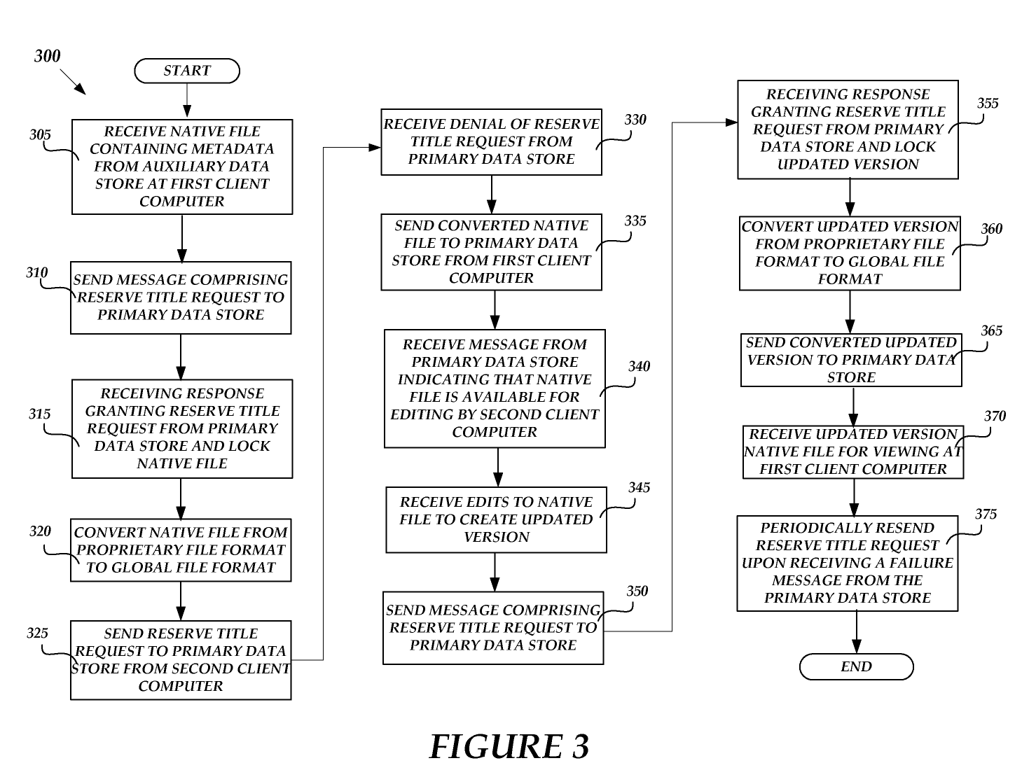

The client computer 2 may include the native file 30, a converted native file 32, client applications 34, and a cookie 52. As discussed above, the native file 30 may comprise a version of a document (e.g., a word processing document) created and/or updated on the client computer 2 in a proprietary file format. The native file 30 may include the metadata 31. The converted native file 32 represents the conversion of the native file 30 from a proprietary file format into a global file format (i.e., a globally viewable document) by the client applications 34. The converted native file 32 may also include the metadata 31 from the native file 30. As will be discussed in greater detail below, the client applications 34 may be configured to convert native files into globally viewable documents so that they may be saved to the primary data store 70 for access and viewing by other client computers. In accordance with an embodiment, the client applications 34 may comprise the OFFICE COMMUNICATOR messaging application and the OFFICE suite of desktop application programs from MICROSOFT CORPORATION of Redmond, Wash. The cookie 52 may comprise a unique identifier associated with the client computer 2 which is used to identify transactions between the client computer 2 and the primary data store 70. Illustrative transactions between the client computer 2 and the primary data store 70 will be described in greater detail below in the discussion of FIG. 3.

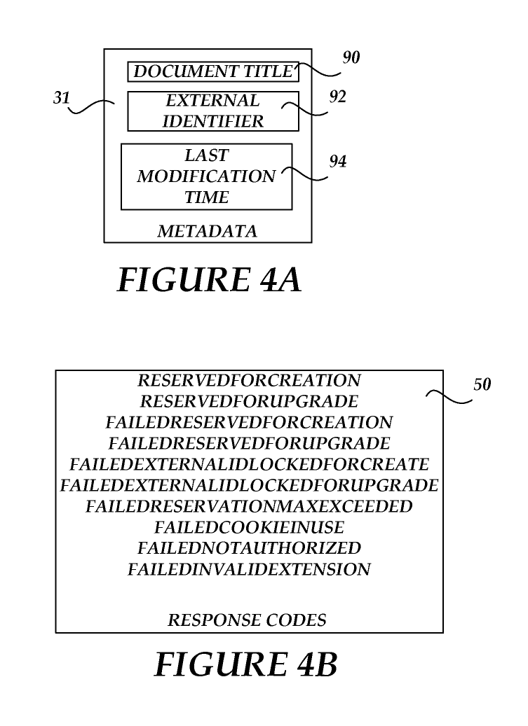

The primary data store 70 may include the converted native file 32 (with the metadata 31) received from the client computer 2, a converted native file 42 (with metadata 31A) received from the client computer 6, a server application 72, response codes 50, a cookie 52, a content identification 54, and an owning user identification 56. In accordance with various embodiments, the primary data store 70 may comprise a server computer that supports a protocol where messages and files can be exchanged between the server and any connected clients. In accordance with an embodiment, the server application 72 on the primary data store 70 may support the aforementioned protocol. In particular, the server application 72 may comprise the OFFICE COMMUNICATIONS SERVER from MICROSOFT CORPORATION of Redmond, Wash. Illustrative operations performed by the server application 72 in connection with coordinating content from multiple data sources, will be described in greater detail below in the discussion of FIG. 3. In accordance with an embodiment, the response codes 50 may comprise messages which are sent to a client computer in response to a request to reserve a title for uploading files to the primary data store 70. The response codes 50 will be described in greater detail below in the discussion of FIGS. 3 and 4B. The cookie 52 may comprise the unique identifier associated with the client computer 2 (or alternatively, the client computer 6) which is used to identify transactions with the primary data store 70. The content identification 54 may comprise an identifier which references existing content on the primary data store 70. The owning user identification 56 may comprise an identifier which references a user (i.e., a client computer) that has received a “reserved title” message (i.e., a “lock”) from the primary data store 70. An illustrative process utilizing the response codes 50, the cookie 52, the content identification 54, and the owning use identification 56 will be described in greater detail below in the discussion of FIG. 3.

The client computer 6 may include the native file 30, a converted native file 42, client applications 34, and the cookie 52A. In accordance with an embodiment, the native file 30 on the client computer 6 may comprise a cached and identical version of the native file 30 stored on the client computer 2. In particular, the native file 30 on the client computer 6 may be a document (e.g., a word processing document) created and/or updated on the client computer 2 in a proprietary file format. The native file 30 may include the metadata 31. The converted native file 42 may comprise an updated (i.e., edited) version of the native file 30 which has been converted from a proprietary file format into a global file format (i.e., a globally viewable document) by the client applications 34. The converted native file 42 may also the metadata 31A. As will be discussed in greater detail below, the client applications 34 may be configured to convert native files into globally viewable documents so that they may be saved to the primary data store 70 for access and viewing by other client computers. In accordance with an embodiment, the client applications 34 may comprise the OFFICE COMMUNICATOR messaging application and the OFFICE suite of desktop application programs from MICROSOFT CORPORATION of Redmond, Wash. The cookie 52A may comprise a unique identifier associated with the client computer 6 which is used to identify transactions between the client computer 6 and the primary data store 70. Illustrative transactions between the client computer 6 and the primary data store 70 will be described in greater detail below in the discussion of FIG. 3.

### Exemplary Operating Environment

Referring now to FIG. 2, the following discussion is intended to provide a brief, general description of a suitable computing environment in which various illustrative embodiments may be implemented. While various embodiments will be described in the general context of program modules that execute in conjunction with program modules that run on an operating system on a personal computer, those skilled in the art will recognize that the various embodiments may also be implemented in combination with other types of computer systems and program modules.

Generally, program modules include routines, programs, components, data structures, and other types of structures that perform particular tasks or implement particular abstract data types. Moreover, those skilled in the art will appreciate that the various embodiments may be practiced with other computer system configurations, including hand-held devices, multiprocessor systems, microprocessor-based or programmable consumer electronics, minicomputers, mainframe computers, and the like. The various embodiments may also be practiced in distributed computing environments where tasks are performed by remote processing devices that are linked through a communications network. In a distributed computing environment, program modules may be located in both local and remote memory storage devices.

FIG. 2 shows the client computer 2 which may include a general purpose desktop, laptop, handheld, tablet, or other type of computer capable of executing one or more application programs. The client computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20.

The client computer 2 further includes a mass storage device 14 for storing an operating system 38, the native file 30 (including the metadata 31), the converted native file 32 (including the metadata 31), the client applications 34, and the cookie 52. In accordance with various embodiments, the operating system 38 may be suitable for controlling the operation of a networked personal computer, such as the WINDOWS operating systems from MICROSOFT CORPORATION of Redmond, Wash. The mass storage device 14 is connected to the CPU 8 through a mass storage controller (not shown) connected to the bus 10. The mass storage device 14 and its associated computer-readable media provide non-volatile storage for the client computer 2. Although the description of computer-readable media contained herein refers to a mass storage device, such as a hard disk or CD-ROM drive, it should be appreciated by those skilled in the art that computer-readable media can be any available media that can be accessed or utilized by the client computer 2. By way of example, and not limitation, computer-readable media may comprise computer storage media and communication media.

Computer storage media includes volatile and non-volatile, removable and non-removable hardware storage media implemented in any physical method or technology for the storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, which can be used to store the desired information and which can be accessed by the client computer 2. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as a computer program product.

According to various embodiments, the client computer 2 may operate in a networked environment using logical connections to remote computers through the network 4 which may comprise, for example, a local network or a wide area network (e.g., the Internet). The client computer 2 may connect to the network 4 through a network interface unit 16 connected to the bus 10. It should be appreciated that the network interface unit 16 may also be utilized to connect to other types of networks and remote computing systems. The client computer 2 may also include an input/output controller 22 for receiving and processing input from a number of input types, including a keyboard, mouse, pen, stylus, finger, and/or other means. Similarly, an input/output controller 22 may provide output to a display device 82, a printer, or other type of output device. Additionally, a touch screen can serve as an input and an output mechanism. It should be appreciated that the client computer 6, the auxiliary data store 74, and the primary data store 70 shown in FIG. 1 may include many of the conventional components shown and discussed above with respect to the client computer 2.

FIG. 3 is a flow diagram illustrating a routine 300 for coordinating content from multiple data sources, in accordance with various embodiments. When reading the discussion of the routines presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIG. 3 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the present invention as recited within the claims set forth herein.

The routine 300 begins at operation 305, where the client applications 34 executing on the client computer 2 receives the native file 30 (containing the metadata 31) from the auxiliary data store 74. In particular, the client computer 2 may receive a document file from the auxiliary data store 74 with metadata identifying the document title. In accordance with another embodiment, the metadata 31 may include other data in addition to a document title. For example, FIG. 4A shows illustrative metadata 31 which includes a document title 90, an external identifier 92, and a last modification time 94. In accordance with an embodiment, the external identifier 92 may comprise a unique identifier which is used by the auxiliary data store 74 but which is not understood by the primary data store 70. It should be understood that different external identifiers may be used by different file stores (e.g., the client computer 2 and the client computer 6). As will be described in greater detail below, the document title 90, the external identifier 92, and the last modification time 94 may be used by the client computers 2 and 6 and the primary data store 70 to compare files and determine if the versions are different and if conflicting edits exists (so that a user can update the file appropriately).

Returning now to FIG. 3, from operation 305, the routine 300 continues to operation 310 where the client applications 34 executing on the client computer 2 send a message comprising a “Reserve Title” request message to the primary data store 70. For example, in accordance with an embodiment, prior to uploading the native file 30, the client computer 2 may send a message containing the document title 90 to the primary data store 70. The primary data store 70 then uses the metadata (e.g., the document title 90) in order to determine if the client computer 2 is authorized to upload the converted version of the native file 30 (i.e., the converted native file 32). In accordance with another embodiment, the Reserve Title request message many include the external identifier 92 and the last modification time 94, in addition to the document title 90. The client applications 34 on the client computer 2 may be configured to access the metadata from the auxiliary data store 74, the primary data store 70, and its own local metadata 31 to determine if a given version of a file is newer than another version so as to prevent uploading an older file version if the primary data store 70 already has a newer version. For example, in accordance with an embodiment, prior to sending the Reserve Title request message, the client applications 34 may determine, based on the document title 90 and the last modification time 94, that the primary data store 70 has a file with a matching document title and that the converted native file 32 on the client computer 2 is more recent than the file on the primary data store. As a result of this determination, the client computer 2 stores the most recent version of the converted native file 32 and thus would send the Reserve Title request message to the primary data store 70. In accordance with another embodiment, prior to sending the Reserve Title request message, the client applications 34 may determine, based on the document title 90 and the external identifier 92, that files on the primary data store 70 have different document titles and different external identifiers. As a result of this determination, the client computer 2 stores the most recent version of the converted native file 32 and thus would send the Reserve Title request message to the primary data store 70. In accordance with yet another embodiment, prior to sending the Reserve Title request message, the client applications 34 may determine, based on the external identifier 92 and the last modification time 94, that the primary data store 70 has a file with an external identifier matching the external identifier of the converted native file 32 and that the converted native file 32 stored on both the client computer 2 and the auxiliary data store 74 is more recent than the file on the primary data store 70. As a result of this determination, the client computer 2 stores the most recent version of the converted native file 32 and thus would send the Reserve Title request message to the primary data store 70.

From operation 310, the routine 300 continues to operation 315 where the client applications 34 executing on the client computer 2 receive a response message (i.e., one of the response codes 50) from the primary data store 70 indicating that the Reserve Title request has been granted and that the native file 30 will be locked from further editing by other client computers (e.g., the client computer 6). In particular, upon granting the Reserve Title request from the client computer 2, the primary data store 70 may canonicalize the document title 90 to prevent other users (e.g., malicious users) from generating similar titles and have previously determined that the document title 90 (and/or the external identification 92) has not already been reserved by another user. For example, the response message from the primary data store 70 may indicate that the native file 30 (as identified by at least the document title 90) may be reserved for creation (i.e., the creation of a document to be saved as the converted native file 32) or reserved for upgrade (i.e., the updating of a document already saved as the converted native file 22). FIG. 4B shows illustrative response codes 50 which may be generated by the primary data store 70 in accordance with various embodiments.

From operation 315, the routine 300 continues to operation 320, where the client applications 34 executing on the client computer 2 converts the native file 30 having a proprietary file format to the converted native file 32 having a global file format (i.e., a globally viewable document).

From operation 320, the routine 300 continues to operation 325, where the client applications 34 executing on the client computer 6 send a Reserve Title request to the primary data store 70. It should be appreciated, that in accordance with an embodiment, the client computer 6 may perform the same determination as discussed above with respect to operation 310, prior to sending the Reserve Title request.

From operation 325, the routine 300 continues to operation 330, where the client computer 6 receives a response message from the primary data store 70 denying the Reserve Title request due to the previously granted request given to the client computer 2 with respect to the native file 30. In particular, the primary data store 70 may send a failure code contained in the response codes 50 because the Reserve Title request granted to the client computer 2 locks out the client computer 6 until the lock is released by the primary data store 70. In accordance with various embodiments, a lock may be released when: (1) a client computer disconnects from the primary data store; (2) a client computer completes uploading a requested file to the primary data store; (3) a state change prevents the client computer from uploading a file (e.g., the client computer loses a network connection to the primary data store); or (4) a client computer sends a “Release Title” message to the primary data store 70. As discussed above at operations 315 and 320, the client computer 2 has already been granted a Reserve Title request for the native file 30 and has converted the native file 30 to a globally viewable format but has not yet uploaded the converted native file 32 to the primary data store 70. Thus, the lock is still active and the client computer 6 will be denied from uploading by the primary data store 70 until the lock has been released.

From operation 330, the routine 300 continues to operation 335, where the client applications 34 executing on the client computer 2 send the converted native file 32 to the primary data store 70. In particular, the client computer 2 may create the converted native file 32 on the primary data store 70 (e.g., if the primary data store 70 does not currently have a file with the same document title or the same document title and the same external identification as the converted native file 32) or update a file already stored on the primary data store 70 with the converted native file 32 (e.g., if the primary data store 70 currently has a file with the same document title or the same document title and the same external identification as the converted native file 32).

From operation 335, the routine 300 continues to operation 340, where the client applications 34 executing on the client computer 6 receive a message from the primary data store 70 indicating that the native file 30 stored on the client computer 6 is available for editing, conversion, and uploading. In particular, after the converted native file 32 has been uploaded from the client computer 2 to the primary data store 70, the lock is released thereby enabling other client computers to upload to the primary data store 70.

From operation 340, the routine 300 continues to operation 345, where the client applications 34 executing on the client computer 6 receive edits to the native file 30 to create an updated version of the file.

From operation 345, the routine 300 continues to operation 350 where the client applications 34 executing on the client computer 6 send a message comprising a “Reserve Title” request message to the primary data store 70. It should be appreciated, that in accordance with an embodiment, the client computer 6 may perform the same determination as discussed above with respect to operation 310, prior to sending the Reserve Title request.

From operation 350, the routine 300 continues to operation 355 where the client applications 34 executing on the client computer 6 receive a response message (i.e., one of the response codes 50) from the primary data store 70 indicating that the Reserve Title request has been granted and that the converted native file 42 will be locked from further editing by other client computers (e.g., the client computer 2). In particular, upon granting the Reserve Title request from the client computer 6, the primary data store 70 may canonicalize the document title 90 to prevent other users (e.g., malicious users) from generating similar titles and have previously determined that the document title 90 (and/or the external identification 92) has not already been reserved by another user. For example, the response message from the primary data store 70 may indicate that the native file 30 (as identified by at least the document title 90) may be reserved for updating.

From operation 355, the routine 300 continues to operation 360, where the client applications 34 executing on the client computer 6 converts the edited/updated native file 30 (not shown) having a proprietary file format to the converted native file 42 having a global file format (i.e., a globally viewable document).

From operation 360, the routine 300 continues to operation 365, where the client applications 34 executing on the client computer 6 send the converted native file 42 to the primary data store 70 as an updated version of the converted native file 32

From operation 365, the routine 300 continues to operation 370, where the client applications 34 executing on the client computer 2 receive the converted native file 42 for viewing. In particular, after the converted native file 42 has been uploaded from the client computer 6 to the primary data store 70, the lock is released thereby enabling the client computer 2 to download the converted native file 42 from the primary data store 70.

From operation 370, the routine 300 continues to operation 375, where the client applications 34 executing on either the client computer 2 or the client computer 6 may periodically resend Reserve Title requests upon receiving a failure message from the primary data store 70. In particular, even when a lock does not prevent a client computer from uploading a file to the primary data store 70, the primary data store 70 may still prevent deny a Reserve Title request under one or more of the following conditions: (1) a maximum number allowed Reserve Title requests has been exceeded; (2) a cookie associated with a requesting client computer is determined to already be in use; (3) a client computer is determined to not be authorized to upload files to the primary data store 70; (4) a client computer has requested to upload a file which has an invalid extension (i.e., a file type that could be used maliciously—such as a .exe file). It should be understood that, in accordance with another embodiment, in addition to periodically resending Reserve Title requests, a client computer (e.g., the client computer 2 or the client computer 6) may additionally also wait until a file is updated before checking with the primary data store 70 (i.e., sending a Reserve Title request) to upload the file. It should further be understood that, in accordance with various embodiments, the primary data store 70 may revoke a Reserve Title request previously granted to a client computer in the event the client computer disconnects from a network connection to the primary data store 70 or because of some other factor, as a result of which, the client computer no longer has rights to update or change a file. From operation 375, the routine 300 then ends.

FIG. 4B is a block diagram illustrating various response codes 50 which may be utilized in coordinating content from multiple data sources, in accordance with an embodiment. The response codes 50 may generated by the primary data store 70 in response to Reserve Title requests and may include the following codes:

ReservedForCreation
ReservedForUpgrade
FailedReservedForCreation
FailedReservedForUpgrade
FailedExternalIDLockedForCreate
FailedExternalIDLockedForUpgrade
FailedReservationMaxExceeded
FailedCookieInUse
FailedNotAuthorized
FailedInvalidExtension

In particular, the primary data store 70 may generate the ReservedForCreation and ReservedForUpgrade codes when a Reserve Title request is granted for uploading and saving a file to the primary data store 70 as either a new file or an updated version of a file already stored on the primary data store 70. The primary data store 70 may generate the FailedReservedForCreation, FailedReservedForUpgrade, FailedExternalIDLockedForCreate, and FailedExternalIDLockedForUpgrade codes when a Reserve Title request is denied when the requested file is currently locked (i.e., the document title 90 or the external identification 92 have already been reserved by another user). The primary data store 70 may generate the FailedReservationMaxExceeded when a maximum number allowed Reserve Title requests has been exceeded. The primary data store 70 may generate the FailedCookielnUse code when a cookie associated with a requesting client computer is determined to already be in use. The primary data store 70 may generate the FailedNotAuthorized code when a client computer is determined to not be authorized to upload files to the primary data store 70. The primary data store 70 may generate the FailedInvalidExtension code when a client computer has requested to upload a file which has an invalid extension (i.e., a file type that could be used maliciously—such as an .exe file).

Although the invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A computer-implemented method of coordinating content from multiple data sources, comprising:
receiving, at a first client computer, a native file from an auxiliary data store, wherein the native file comprises metadata, the metadata comprising a document title;
sending, from the first client computer, a message comprising a reserve title request to the primary data store, the reserve title request comprising the document title;
receiving, at the first client computer, a response granting the reserve title request from the primary data store, wherein upon receiving the response, the native file is locked from further editing by another client computer;
converting, at the first client computer, the native file from a proprietary file format to a global file format; and
sending, from the first client computer, the converted native file to the primary data store.

2. The method of claim 1, further comprising:
sending, from at least one other client computer, a reserve title request to the primary data store, the reserve title request comprising a document title associated with a cached version of the native file; and
receiving, at the at least one other client computer, a denial of the reserve title request from the primary data store.

3. The method of claim 2, further comprising:
receiving, at the at least one other client computer, a message from the primary data store indicating that the native file is available for editing by the at least one other client computer; and
receiving edits to the native file at the at least one other client computer to create an updated version of the native file.

4. The method of claim 3, further comprising:
sending, from the at least one other client computer, a reserve title request to the primary data store, the reserve title request comprising the document title associated with the updated version of the native file; and
receiving, at the at least one other client computer, a response granting the reserve title request from the primary data store, wherein upon receiving the response, the updated version of the native file is locked from further editing by the first client computer.

5. The method of claim 4, further comprising:
converting, at the at least one other client computer, the updated version of the native file into from a proprietary file format to a global file format;
sending, from the at least one other client computer, the converted updated version of the native file to the primary data store; and

6. The method of claim 4, further comprising receiving, at the first client computer, the updated version of the native file for viewing.

7. The method of claim 1, further comprising periodically resending, from at least one of the first client computer and the at least one other client computer, the reserve title request upon receiving a failure message from the primary data store.

8. A system for coordinating content from multiple data sources, comprising:
an auxiliary data store;
a primary data store; and
a first client computer comprising a memory for storing executable program code and a processor, wherein the processor is functionally coupled to the memory and responsive to computer-executable instructions contained in the program code, wherein the processor is operative to:
receive a native file from an auxiliary data store, wherein the native file comprises metadata, the metadata comprising a document title;
send a message comprising a reserve title request to the primary data store, the reserve title request comprising the document title;
receive a response granting the reserve title request from the primary data store, wherein upon receiving the response, the native file is locked from further editing by another client computer;
convert the native file from a proprietary file format to a global file format; and;
send the converted native file to the primary data store.

9. The system of claim 8, further comprising a second client computer comprising a memory for storing executable program code and a processor, wherein the processor is functionally coupled to the memory and responsive to computer-executable instructions contained in the program code, wherein the processor is operative to:
send a reserve title request to the primary data store, the reserve title request comprising a document title associated with a cached version of the native file; and
receive a denial of the reserve title request from the primary data store.

10. The system of claim 9, wherein the processor of the second client computer is further operative to:
receive a message from the primary data store indicating that the native file is available for editing by the second client computer; and
receive edits to the native file at the second client computer to create an updated version of the native file.

11. The system of claim 10, wherein the processor of the second client computer is further operative to:
send a reserve title request to the primary data store, the reserve title request comprising the document title associated with the updated version of the native file; and
receive a response granting the reserve title request from the primary data store, wherein upon receiving the response, the updated version of the native file is locked from further editing by the first client computer.

12. The system of claim 11, wherein the processor of the second client computer is further operative to:
convert the updated version of the native file into from a proprietary file format to a global file format; and
send the converted updated version of the native file to the primary data store.

13. The system of claim 12, wherein the processor of the first client computer is further operative to receive the updated version of the native file for viewing.

14. The system of claim 8, wherein the processor of at least one of the first client computer and the second client computer is further operative to periodically resend the reserve title request upon receiving a failure message from the primary data store.

15. A method of coordinating content from multiple data sources, comprising:
receiving, at a first client computer, a native file from an auxiliary data store, wherein the native file comprises metadata, the metadata comprising a document title, an external identifier, and a last modification time;
sending, from the first client computer, a message comprising a reserve title request to the primary data store, the reserve title request comprising the document title, the external identifier, and the last modification time;
receiving, at the first client computer, a response granting the reserve title request from the primary data store, wherein upon receiving the response, the native file is locked from further editing by another client computer;
converting, at the first client computer, the native file from a proprietary file format to a global file format;
sending, from a second client computer, a reserve title request to the primary data store, the reserve title request comprising a document title, an external identifier, and a last modification time associated with a cached version of the native file;
receiving, at the second client computer, a denial of the reserve title request from the primary data store;
sending, from the first client computer, the converted native file to the primary data store;
receiving, at the second client computer, a message from the primary data store indicating that the native file is available for editing by the second client computer;
receiving edits to the native file at the second client computer to create an updated version of the native file;
sending, from the second client computer, a reserve title request to the primary data store, the reserve title request comprising a document title, an external identifier, and a last modification time associated with the updated version of the native file;
receiving, at the second client computer, a response granting the reserve title request from the primary data store, wherein upon receiving the response, the updated version of the native file is locked from further editing by the first client computer;
converting, at the second client computer, the updated version of the native file into from a proprietary file format to a global file format;
sending, from the second client computer, the converted updated version of the native file to the primary data store; and
receiving, at the first client computer, the updated version of the native file for viewing.

16. The method of claim 15, wherein sending, from the first client computer, a message comprising a reserve title request to the primary data store, the reserve title request comprising the document title, the external identifier, and the last modification time comprises:
determining, based at least on the document title and the last modification time, that the primary data store has a file with a document title matching the document title of the native file on the first client computer and that the native file on the first client computer is more recent than the file on the primary data store; and
sending the message comprising the reserve title request to the primary data store.

17. The method of claim 15, wherein sending, from the first client computer, a message comprising a reserve title request to the primary data store, the reserve title request comprising the document title, the external identifier, and the last modification time comprises:
determining, based at least on the external identifier and the last modification time, that the primary data store has a file with an external identifier matching the external identifier of the native file on at least one of the first client computer and the auxiliary data store and that the native file on the at least one of the first client computer and the auxiliary data store is more recent than the file on the primary data store; and
sending the message comprising the reserve title request to the primary data store.

18. The method of claim 15, wherein sending, from the first client computer, a message comprising a reserve title request to the primary data store, the reserve title request comprising the document title, the external identifier, and the last modification time comprises:
determining, based at least on the document title and the external identifier, that files in the primary data store have different document titles and different external identifiers; and
sending the message comprising the reserve title request to the primary data store.

19. The method of claim 15, wherein receiving, at the first client computer, a response granting the reserve title request from the primary data store, comprises receiving a response code and at least one of a cookie, a content identification, and an owning user identification from the primary data store, wherein the response code indicates that the native file is at least one of reserved for creation and reserved for upgrade, wherein the cookie comprises an external identifier used to correlate future messages received by the first client computer which are related to the reserve title request, wherein the content identification comprises a reference to existing content in the primary data store, and wherein the owning user identification identifies a user owning an existing lock of the native file.

20. The method of claim 15, further comprising periodically resending, from at least one of the first client computer and the second client computer, the reserve title request upon receiving a failure message from the primary data store.
